(19) United States
(12) Patent Application Publication
(10) Pub. No.: US 2020/0086860 A1
(43) Pub. Date: Mar. 19, 2020

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Hiroshi Oguro, Wako-shi (JP); Katsuya Yashiro, Wako-shi (JP); Toshiyuki Kaji, Wako-shi (JP); Toru Kokaki, Wako-shi (JP); Masanori Takeda, Wako-shi (JP)

(21) Appl. No.: 16/495,121

(22) PCT Filed: Feb. 15, 2018
(86) PCT No.: PCT/JP2018/005254

§ 371 Date: Sep. 18, 2019

(30) Foreign Application Priority Data
Mar. 31, 2017 (JP) 2017-072421

(51) Int. Cl. B60W 30/09; B60W 30/095; G05D 1/02; G05D 1/00

(52) U.S. Cl. CPC B60W 30/09; B60W 30/0956; G05D 2201/0213; G05D 1/0088; B60W 2550/10; G05D 1/0214

(57) ABSTRACT

A vehicle control system includes: a detection unit configured to detect an obstacle in front of a vehicle; a risk determining unit configured to determine a degree of risk to a vehicle of the obstacle detected by the detection unit; and an action plan generating unit configured to search for a retreat destination candidate for the vehicle, determine a degree of safety of the retreat destination candidate, and generate a retreat action plan for the vehicle on the basis of a result of the determination of the degree of safety of the retreat destination candidate in a case in which the degree of risk determined by the risk determining unit is equal to or higher than a threshold.

### TECHNICAL FIELD

The present invention relates to a vehicle control system, a vehicle control method, and a vehicle control program.

Priority is claimed on Japanese Patent Application No. 2017-072421, filed Mar. 31, 2017, the content of which is incorporated herein by reference.

### BACKGROUND ART

In recent years, technologies for automatedly controlling at least one of acceleration/deceleration and steering of a vehicle such that the vehicle runs along a path to a destination (hereinafter referred to as “automated driving”) have been researched. A driving supporting system that stops a vehicle on the side of a road in a case in which an emergency earthquake report is received has been proposed (for example, see Patent Literature 1).

### CITATION LIST

### Patent Literature

[Patent Literature 1]

Japanese Unexamined Patent Application, First Publication No. 2012-123835

### SUMMARY OF INVENTION

### Technical Problem

Additional improvement of safety of vehicles has been anticipated.

An aspect of the present invention is in consideration of such situations, and one objective thereof is to provide a vehicle control system, a vehicle control method, and a vehicle control program capable of achieving additional improvement of safety.

### Solution to Problem

(1) According to one aspect of the present invention, a vehicle control system is provided, including: a detection unit configured to detect an obstacle in front of a vehicle; a risk determining unit configured to determine a degree of risk of a vehicle for the obstacle detected by the detection unit; and an action plan generating unit configured to search for a retreat destination candidate for the vehicle, determine a degree of safety of the retreat destination candidate, and generate a retreat action plan for the vehicle on the basis of a result of the determination of the degree of safety of the retreat destination candidate in a case in which the degree of risk determined by the risk determining unit is equal to or higher than a threshold.

(2) In the aspect (1) described above, the action plan generating unit may search for a plurality of retreat destination candidates, determine a degree of safety of each of the plurality of retreat destination candidates, and generate the retreat action plan on the basis of a result of the determination of the degree of safety of each of the plurality of retreat destination candidates.

(3) In the aspect (2) described above, the plurality of retreat destination candidates may include a first retreat destination candidate and a second retreat destination candidate that is located farther away than the first retreat destination candidate when seen from the vehicle, and the action plan generating unit may generate a retreat action plan for the vehicle to retreat to the second retreat destination candidate in a case in which a degree of safety of the second retreat destination candidate is higher than a degree of safety of the first retreat destination candidate.

(4) In any one of the aspects (1) to (3) described above, the action plan generating unit may determine the degree of safety of the retreat destination candidate on the basis of at least a degree of ease for a vehicle occupant to evacuate from the retreat destination candidate.

(5) In the aspect (4) described above, the action plan generating unit may determine the degree of safety of the retreat destination candidate on the basis of at least a degree of freedom in the periphery of the retreat destination candidate as the degree of ease for the vehicle occupant to evacuate from the retreat destination candidate.

(6) In the aspect (4) or (5) described above, the action plan generating unit may determine the degree of safety of the retreat destination candidate on the basis of at least a degree of ease for the vehicle occupant to move to an evacuation path as the degree of ease for the vehicle occupant to evacuate from the retreat destination candidate.

(7) In any one of the aspects (1) to (6) described above, in a case in which the vehicle is caused to stop in accordance with the retreat action plan, the action plan generating unit may set a space wider than a space set in front of the vehicle at the time of stopping the vehicle as a front space of the vehicle in automated driving realized by an automated driving control unit executing at least one of speed control and steering control of the vehicle.

(8) In any one of the aspects (1) to (7) described above, an automatic driving mode control unit configured to switch a driving mode of the vehicle to a limited automated driving mode in which at least one of an operation for the vehicle and a moving range of the vehicle is limited and an acceptance unit configured to accept a guidance instruction from the outside in the limited automated driving mode may be further included, and the action plan generating unit may generate an action plan for the vehicle in the limited automated driving mode on the basis of the guidance instruction accepted by the acceptance unit.

(9) According to one aspect of the present invention, a vehicle control method using an in-vehicle computer is provided, the vehicle control method including: detecting an obstacle in front of a vehicle; determining a degree of risk to a vehicle of the obstacle; and searching for a retreat destination candidate for the vehicle, determining a degree of safety of the retreat destination candidate, and generating a retreat action plan for the vehicle on the basis of a result of the determination of the degree of safety of the retreat destination candidate in a case in which the degree of risk is equal to or higher than a threshold.

(10) According to one aspect of the present invention, a vehicle control program is provided causing an in-vehicle computer to execute: detecting an obstacle in front of a vehicle; determining a degree of risk to a vehicle of the obstacle; and searching for a retreat destination candidate for the vehicle, determining a degree of safety of the retreat destination candidate, and generating a retreat action plan for the vehicle on the basis of a result of the determination of the degree of safety of the retreat destination candidate in a case in which the degree of risk is equal to or higher than a threshold.

### Advantageous Effects of Invention

According to the aspects (1), (9), and (10) described above, in a case in which there is an obstacle of which a degree of risk is high in front of a vehicle, a retreat action plan for the vehicle is generated on the basis of the degree of safety of the retrieved retreat destination candidate. For this reason, the vehicle can retreat to a retreat destination candidate that is safer or a retreat destination candidate of which the degree of safety is equal to or higher than a predetermined level. Accordingly, additional improvement of safety of the vehicle can be achieved.

According to the aspect (2) described above, a retreat action plan for the vehicle is generated on the basis of the degree of safety of each of a plurality of retreat destination candidates. For this reason, the vehicle can retreat to a more appropriate retreat destination candidate among a plurality of retreat destination candidates such as a safer retreat destination candidate, a closer retreat destination candidate of which the degree of safety is equal to or higher than a predetermined level, or the like. In this way, additional improvement of safety of the vehicle can be achieved.

According to the aspect (3) described above, in a case in which the degree of safety of a second retreat destination candidate that is located relatively far is higher than the degree of safety of a first retreat destination candidate that is located relatively close when seen from the vehicle, a retreat action plan for the vehicle to retreat to the second retreat destination candidate is generated. In this way, additional improvement of safety of the vehicle can be achieved.

According to the aspect (4) described above, the degree of safety of the retreat destination candidate is determined on the basis of the degree of ease for the vehicle occupant to evacuate. For this reason, the safety of the vehicle occupant can be secured at a higher level.

According to the aspect (5) described above, the degree of safety of a retreat destination candidate is determined on the basis of the degree of freedom of the retreat destination candidate for the periphery. For this reason, a vehicle occupant who has got off the vehicle that stopped at the retreat destination candidate can have a degree of freedom of evacuation at a higher level. In this way, the safety of the vehicle occupant can be secured at a further higher level.

According to the aspect (6) described above, the degree of safety of a retreat destination candidate is determined on the basis of the degree of ease for the vehicle occupant to move to the evacuation path. For this reason, the vehicle occupant who has got off the vehicle that stopped at the retreat destination candidate can move to the evacuation path more easily. In this way, the safety of the vehicle occupant can be secured at a further higher level.

According to the aspect (7) described above, in a case in which the vehicle stops in accordance with the retreat action plan, a relatively wide space is secured in front of the vehicle. Accordingly, for example, in a case in which an emergency vehicle or a vehicle relating to accident handling passes nearby, the vehicle can be easily moved using the space. In this way, an emergency activity, an accident handling activity, and the like can be easily performed.

According to the aspect (8) described above, also after the vehicle stops in accordance with the retreat action plan, and a driver gets off the vehicle, the vehicle can be moved in accordance with a guidance instruction of a third party such as an emergency rescue member, a policeman, or the like. Accordingly, an emergency rescue activity, an accident handling activity, and the like can be performed more easily.

### BRIEF DESCRIPTION OF DRAWINGS

FIG. 1 is a configuration diagram of a vehicle system according to an embodiment.

FIG. 2 is a diagram illustrating a view in which a relative position and a posture of a subject vehicle M with respect to a running lane are recognized by a subject vehicle position recognizing unit.

FIG. 3 is a diagram illustrating a view in which a target locus is generated on the basis of a recommended lane.

FIG. 4 is a configuration diagram illustrating the function of a vehicle system relating to an encounter with an obstacle.

FIG. 5 is a diagram illustrating one example of a plurality of retreat destination candidates retrieved by a retreat destination candidate searching unit.

FIG. 6 is a diagram illustrating another example of a plurality of retreat destination candidates retrieved by a retreat destination candidate searching unit.

FIG. 7 is a diagram illustrating yet another example of a plurality of retreat destination candidates retrieved by a retreat destination candidate searching unit.

FIG. 8 is a flowchart illustrating one example of a process flow of a vehicle system.

### DESCRIPTION OF EMBODIMENTS

Hereinafter, a vehicle control system, a vehicle control method, and a vehicle control program according to an embodiment of the present invention will be described with reference to the drawings.

Hereinafter, a case in which left-side traffic regulations are applied will be described. The left side and the right side may be interchanged in a road in which a rule of right-side traffic is applied.

“Based on XX” stated in this specification means “at least based on XX” and also includes the case of being based on other elements in addition to XX. In addition, “based on XX” is not limited to the case of directly using XX and also includes the case of being based on an arithmetic operation or processing performed for XX. Here, “XX” is an arbitrary element (for example, an arbitrary index, a physical quantity, or any other information).

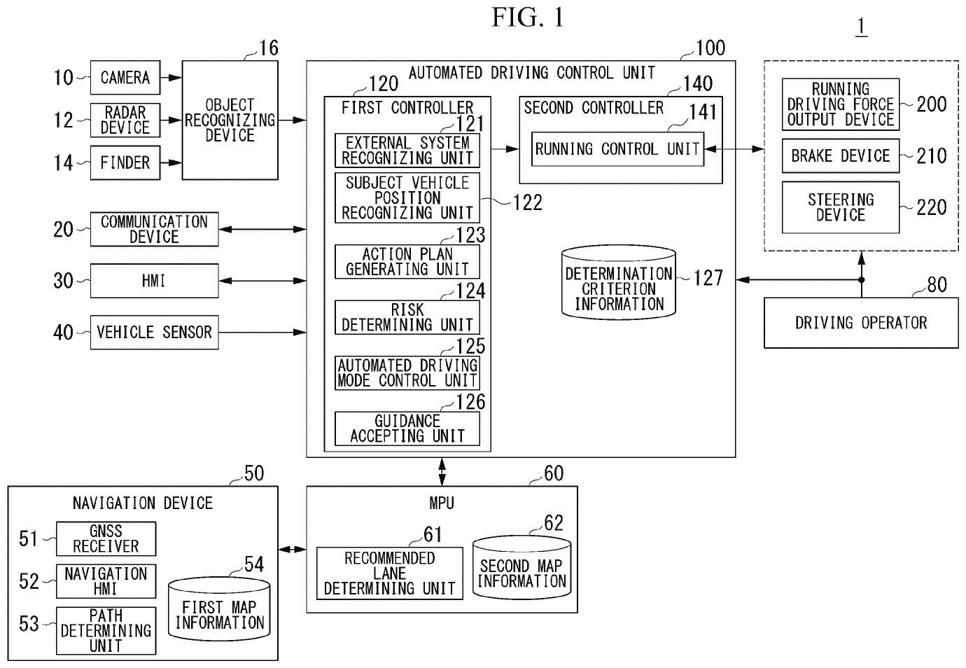

FIG. 1 is a configuration diagram of a vehicle system 1 according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. An electric motor operates using power generated using a power generator connected to an internal combustion engine or discharge power of a secondary cell or a fuel cell.

The vehicle system 1, for example, includes a camera 10, a radar device 12, a finder 14, an object recognizing device 16, a communication device 20, a human machine interface (HMI) 30, a vehicle sensor 40, a navigation device 50, a micro-processing unit (MPU) 60, a driving operator 80, an automated driving control unit 100, a running driving force output device 200, a brake device 210, and a steering device 220. Such devices and units are interconnected using a multiplex communication line such as a controller area network (CAN) communication line, a serial communication line, a radio communication network, or the like. The configuration illustrated in FIG. 1 is merely one example, and thus, some components may be omitted, and, furthermore, another component may be added thereto. A “vehicle control system”, for example, includes a camera 10, a radar device 12, a finder 14, an object recognizing device 16, a communication device 20, a human machine interface (HMI) 30, a vehicle sensor 40, a navigation device 50, a micro-processing unit (MPU) 60, and an automated driving control unit 100

The camera 10, for example, is a digital camera using a solid-state imaging device such as a charge coupled device (CCD) or a complementary metal oxide semiconductor (CMOS). One or a plurality of cameras 10 are installed at arbitrary places in a vehicle (hereinafter, referred to as a subject vehicle M) in which the vehicle control system is mounted. In a case in which the side in front is to be imaged, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radiowaves such as millimeter waves to the vicinity of the subject vehicle M and detects at least a position (a distance and an azimuth) of an object by detecting radiowaves (reflected waves) reflected by the object. One or a plurality of radar devices 12 are installed at arbitrary places in the subject vehicle M. The radar device 12 may detect a position and a speed of an object using a frequency modulated continuous wave (FM-CW) system.

The finder 14 is a light detection and ranging or a laser imaging detection and ranging (LIDAR) finder that detects a distance to a target by measuring light scattered from emitted light. One or a plurality of finders 14 are installed at arbitrary places in the subject vehicle M.

The object recognizing device 16 may perform a sensor fusion process on results of detection using some or all of the camera 10, the radar device 12, and the finder 14, thereby recognizing a position, a type, a speed, and the like of an object. The object recognizing device 16 outputs a result of recognition to the automated driving control unit 100.

The communication device 20, for example, communicates with other vehicles (one example of nearby vehicles) present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to a vehicle occupant of the subject vehicle M and receives an input operation performed by a vehicle occupant. The HMI 30 includes various display devices, a speaker, a buzzer, a touch panel, a switch, a key, and the like.

The vehicle sensor 40 includes a vehicle speed sensor detecting a speed of the subject vehicle M, an acceleration sensor detecting an acceleration, a yaw rate sensor detecting an angular velocity around a vertical axis, an azimuth sensor detecting an azimuth of the subject vehicle M, and the like. The vehicle sensor 40 outputs detected information (a speed, an acceleration, an angular velocity, an azimuth, and the like) to the automated driving control unit 100.

The navigation device 50, for example, includes a global navigation satellite system (GNSS) receiver 51, a navigation HMI 52, and a path determining unit 53 and stores first map information 54 in a storage device such as a hard disk drive (HDD) or a flash memory. The GNSS receiver 51 identifies a position of the subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The path determining unit 53, for example, determines a path from a location of the subject vehicle M identified by the GNSS receiver 51 (or an input arbitrary location) to a destination input by a vehicle occupant using the navigation HMI 52 by referring to the first map information 54. The first map information 54, for example, is information in which a road form is represented by respective links representing a road and respective nodes connected using the links. The first map information 54 may include a curvature of each road, point of interest (POI) information, and the like. The path determined by the path determining unit 53 is output to the MPU 60. The navigation device 50 may perform path guidance using the navigation HMI 52 on the basis of the path determined by the path determining unit 53. The navigation device 50, for example, may be realized by a function of a terminal device such as a smartphone or a tablet terminal carried by a user. The navigation device 50 may transmit a current location and a destination to a navigation server through the communication device 20 and acquire a path received from the navigation server as a reply.

The MPU 60, for example, functions as a recommended lane determining unit 61 and maintains second map information 62 in a storage device such as an HDD or a flash memory. The recommended lane determining unit 61 divides a path provided from the navigation device 50 into a plurality of blocks (for example, divides the path into blocks of 100 m in the advancement direction of the vehicle) and determines a recommended lane for each block by referring to the second map information 62. The recommended lane determining unit 61 determines in which lane to run from the left side. In a case in which a branching place, a merging place, or the like is present in the path, the recommended lane determining unit 61 determines a recommended lane such that the subject vehicle M can run on a reasonable path for advancement to divergent destinations.

The second map information 62 is map information having an accuracy higher than that of the first map information 54. The second map information 62, for example, includes information of the center of respective lanes, information on boundaries between lanes, or the like. In addition, in the second map information 62, road information, traffic regulations information, address information (address and zip code), facilities information, telephone information, and the like may be included. In the road information, information representing a type of road such as an expressway, a toll road, a national highway, or a prefectural road and information such as the number of lanes of a road, a width of each lane, a gradient of a road, a position of a road (three-dimensional coordinates including longitude, latitude, and a height), a curvature of the curve of a lane, locations of merging and branching points of lanes, a sign installed on a road, and the like are included. The second map information 62 may be updated as is necessary by accessing another device using the communication device 20.

The driving operator 80, for example, includes an acceleration pedal, a brake pedal, a shift lever, a steering wheel, and the like. A sensor detecting the amount of an operation or the presence/absence of an operation is installed in the driving operator 80, and a result of detection thereof is output to the automated driving control unit 100 or the running driving force output device 200, and one or both of the brake device 210 and the steering device 220.

The automated driving control unit (automated driving control part) 100, for example, includes a first control unit 120 and a second control unit 140. Each of the first control unit 120 and the second control unit 140 is realized by a processor such as a central processing unit (CPU) executing a program (software). Some or all of the functional units of the first control unit 120 and the second control unit 140 may be realized by hardware such as a large scale integration (LSI), an application specific integrated circuit (ASIC), a field-programmable gate array (FPGA), or the like or may be realized by software and hardware in cooperation. The program may be stored in a storage device such as a hard disk drive (HDD) or a flash memory in advance or may be stored in a removable storage medium such as a DVD or a CD-ROM and be installed in the storage device by loading the storage medium into a drive device.

The first control unit 120, for example, includes an external system recognizing unit 121, a subject vehicle position recognizing unit 122, an action plan generating unit 123, a risk determining unit 124, an automated driving mode control unit 125, and a guidance accepting unit 126. The risk determining unit 124, the automated driving mode control unit 125, and the guidance accepting unit 126 will be described in detail later.

The external system recognizing unit 121 recognizes states of nearby vehicles such as positions, speeds, and accelerations on the basis of information input from the camera 10, the radar device 12, and the finder 14 through the object recognizing device 16. The position of a nearby vehicle may be represented as a representative point of the nearby vehicle such as the center of gravity, a corner, or the like and may be represented by an area represented by the contour of the nearby vehicle. The “state” of a nearby vehicle may include an acceleration or a jerk or may be an “action state” (for example, the vehicle is changing lanes or is to change lanes) of the nearby vehicle. The external system recognizing unit 121 may recognize positions of a guard rail and a telegraph pole, a parked vehicle, a pedestrian, and other objects in addition to the nearby vehicles.

The subject vehicle position recognizing unit 122, for example, recognizes a lane (running lane) in which the subject vehicle M runs and a relative position and a posture of the subject vehicle M with respect to the running lane. The subject vehicle position recognizing unit 122, for example, by comparing a pattern (for example, an array of solid lines and broken lines) of a road partition line that is acquired from the second map information 62 with a pattern of the road partition line in the vicinity of the subject vehicle M that is recognized from an image captured by the camera 10, recognizes a running lane. In the recognition, the position of the subject vehicle M acquired from the navigation device 50 and a processing result acquired using the INS may be added.

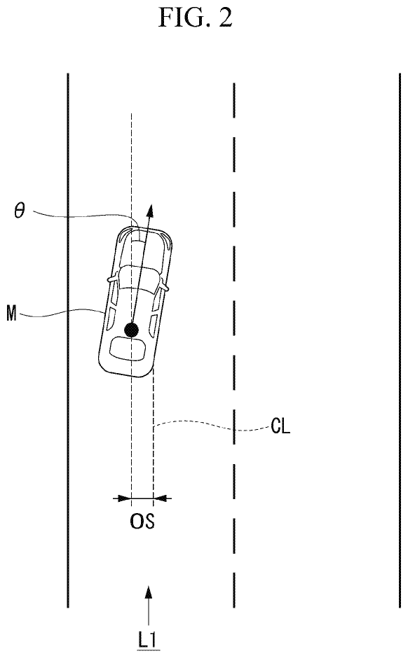

Then, the subject vehicle position recognizing unit 122, for example, recognizes a position and a posture of the subject vehicle M with respect to the running lane. FIG. 2 is a diagram illustrating a view in which a relative position and a posture of a subject vehicle M with respect to a running lane L1 are recognized by the subject vehicle position recognizing unit 122. The subject vehicle position recognizing unit 122, for example, recognizes an offset OS of a reference point (for example, center of gravity) of the subject vehicle M from running lane center CL and an angle θ of an advancement direction of the subject vehicle M formed with respect to a line acquired by aligning the running lane center CL as a relative position and a posture of the subject vehicle M with respect to the running lane L1. Instead of this, the subject vehicle position recognizing unit 122 may recognize a position of the reference point of the subject vehicle M with respect to one side end of its own lane L1 or the like as a relative position of the subject vehicle M with respect to the running lane. The relative position of the subject vehicle M recognized by the subject vehicle position recognizing unit 122 is provided for the recommended lane determining unit 61 and the action plan generating unit 123.

The action plan generating unit 123 determines events to be sequentially executed in automated driving such that the subject vehicle M runs in a recommended lane determined by the recommended lane determining unit 61 and deals with a surrounding status of the subject vehicle M. As the events, for example, there are a constant-speed running event in which the subject vehicle runs at a constant speed in the same running lane, a following running event in which the subject vehicle follows a vehicle running ahead, a lane changing event, a merging event, a branching event, an emergency stop event, a handover event for ending automated driving and switching to manual driving, and the like. During the execution of such an event, there are cases in which an action for avoidance is planned on the basis of surrounding statuses of the subject vehicle M (the presence/absence of nearby vehicles and pedestrians, lane contraction according to road construction, and the like).

The action plan generating unit 123 generates a target locus in which the subject vehicle M will run in the future. The target locus is represented as a sequence in which places (locus points) at which the subject vehicle M will arrive are sequentially aligned. A locus point is a place at which the subject vehicle M will arrive at respective predetermined running distances, and separately from that, a target speed and a target acceleration for each of predetermined sampling times (for example, a fraction of a [sec]) are generated as a part of the target locus. A locus point may be a position at which the subject vehicle M will arrive at a predetermined sampling time for each of the predetermined sampling times. In such a case, information of a target speed and a target acceleration is represented using intervals between the locus points.

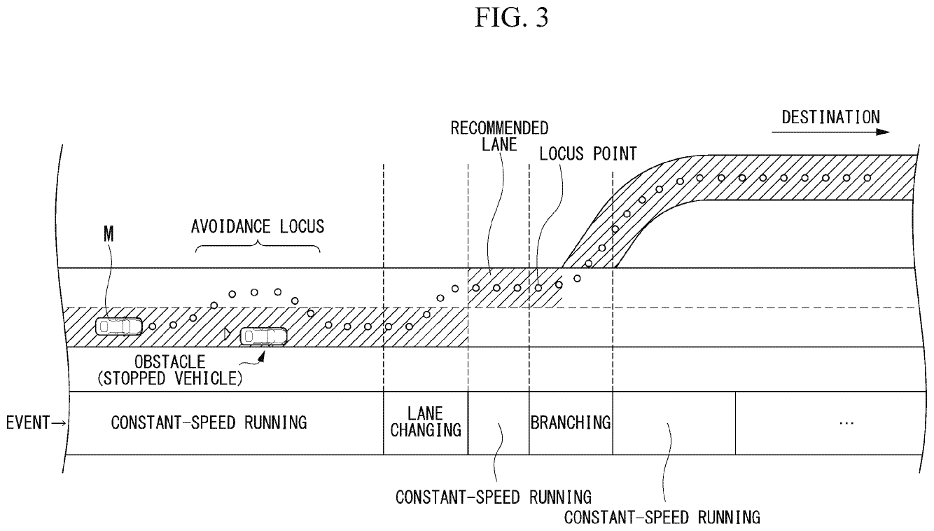

FIG. 3 is a diagram illustrating a view in which a target locus is generated on the basis of a recommended lane. As illustrated in the drawing, the recommended lane is set such that it is convenient for the subject vehicle to run along a path to a destination.

When the subject vehicle reaches a position a predetermined distance before a recommended lane switching place (which may be determined in accordance with a type of event), the action plan generating unit 123 starts the lane changing event, the branching event, the merging event, or the like. In a case in which there is a need to avoid an obstacle during the execution of each event, as illustrated in the drawing, an avoidance locus is generated.

The action plan generating unit 123, for example, generates a plurality of candidates for a target locus and selects a target locus that is optimal at that time point on the basis of the viewpoints of safety and efficiency.

According to the configuration described above, the automated driving control unit 100 realizes automated driving in which at least one of speed control and steering control of the subject vehicle M is automatedly performed. For example, the automated driving control unit 100 realizes an automated driving mode in which both the speed control and steering control of the subject vehicle M are automatedly performed.

Referring back to the description presented with reference to FIG. 1, the second control unit 140 includes a running control unit 141. The running control unit 141 controls the running driving force output device 200, the brake device 210, and the steering device 220 such that the subject vehicle M passes through a target locus generated by the action plan generating unit 123 at a scheduled time.

The running driving force output device 200 outputs a running driving force (torque) for allowing the vehicle to run to driving wheels. The running driving force output device 200, for example, includes a combination of an internal combustion engine, an electric motor, a transmission gear, and the like and an ECU controlling such components. The ECU controls the components described above on the basis of information input from the running control unit 141 or information input from the driving operator 80.

The brake device 210, for example, includes a brake caliper, a cylinder delivering hydraulic pressure to the brake caliper, an electric motor generating hydraulic pressure in the cylinder, and a brake ECU. The brake ECU controls the electric motor on the basis of the information input from the running control unit 141 or the information input from the driving operator 80 such that a brake torque corresponding to a braking operation is output to each vehicle wheel. The brake device 210 may include a mechanism that delivers a hydraulic pressure generated in accordance with an operation for a brake pedal included in the driving operator 80 to the cylinder through a master cylinder as a backup. The brake device 210 is not limited to the configuration described above and may be an electronic control-type hydraulic brake device that delivers a hydraulic pressure of the master cylinder to the cylinder by controlling an actuator on the basis of information input from the running control unit 141.

The steering device 220, for example, includes a steering ECU and an electric motor. The electric motor, for example, changes the direction of the steering wheel by applying a force to a rack and pinion mechanism. The steering ECU changes the direction of the steering wheel by driving the electric motor in accordance with information input from the running control unit 141 or information input from the driving operator 80.

Next, the function of the vehicle system 1 relating to an encounter with an obstacle will be described in detail.

The vehicle system 1 according to this embodiment further increases a degree of safety of a vehicle occupant of a subject vehicle M in a case in which an obstacle such as a vehicle involved in an accident is detected in front of the subject vehicle M.

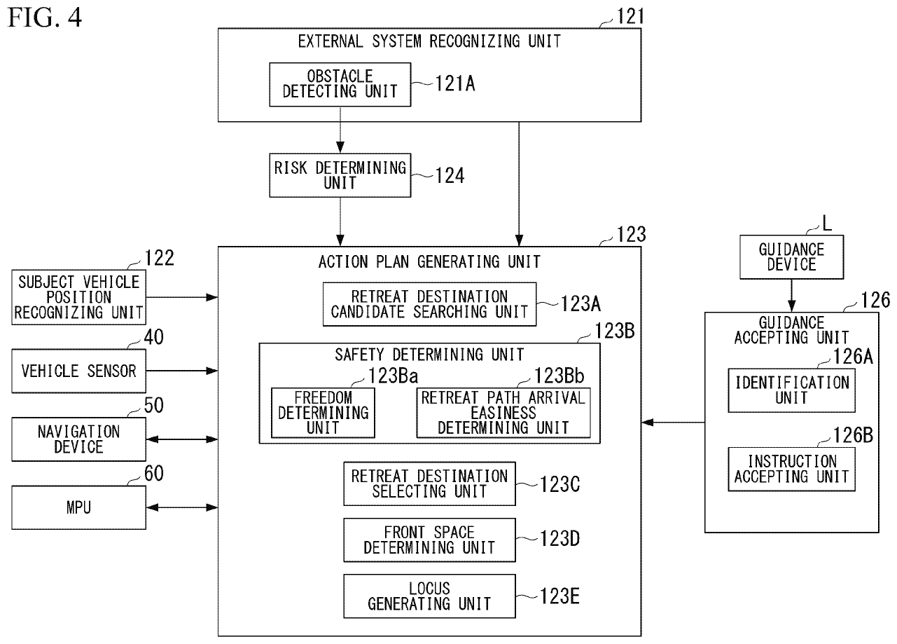

FIG. 4 is a configuration diagram illustrating the function of a vehicle system 1 relating to an encounter with an obstacle. As illustrated in the drawing, the external system recognizing unit 121 includes an obstacle detecting unit 121A.

In a case in which there is an obstacle in front of the subject vehicle M, the obstacle detecting unit (a detection unit) 121A detects the obstacle, for example, on the basis of information input from the camera 10, the radar device 12, and the finder 14 through the object recognizing device 16. An “obstacle,” for example, is a vehicle involved in an accident which has stopped or rolled over on a road, a fallen object that has fallen from a vehicle running ahead, a fallen object that has fallen from an upper structure such as a tunnel or a bridge, a natural phenomenon such as a crack of a road, a fire, or a flood, or the like but is not limited thereto. “Obstacle” broadly means a physical tangible entity or an intangible entity that disturbs running of the subject vehicle M. An “obstacle” may be called an “obstacle event.” The obstacle detecting unit 121A, for example, detects a kind, a size, and the like of an obstacle present in front of the subject vehicle M on the basis of information input from the camera 10, the radar device 12, and the finder 14 through the object recognizing device 16. The obstacle detecting unit 121A may detect the possibility of a secondary disaster such as a fire on the basis of the type and the like of a detected obstacle. The obstacle detecting unit 121A may detect the presence/absence, type, size, possibility of a secondary disaster, and the like of an obstacle on the basis of information received from a vehicle involved in an accident or a nearby vehicle running ahead of the subject vehicle M through the communication device 20, information received from a communication facility installed on a road through the communication device 20, or the like instead of or in addition to information input from the camera 10 and the like. The obstacle detecting unit 121A outputs a detection result acquired by the obstacle detecting unit 121A to the risk determining unit 124.

The risk determining unit 124 determines (evaluates) a degree of risk to the subject vehicle M of an obstacle detected by the obstacle detecting unit 121A. For example, the risk determining unit 124 determines a degree of risk to the subject vehicle M on the basis of at least one of a type, a size, the possibility of a secondary disaster, and the like of an obstacle detected by the obstacle detecting unit 121A. In a specific example, determination criterion information 127 (see FIG. 1) used as criteria for various determinations is stored in a storage device (an HDD, a flash memory, or the like) of the vehicle system 1. The risk determining unit 124 determines a magnitude of a degree of risk to the subject vehicle M by comparing at least one of a type, a size, a possibility of a secondary disaster, and the like of an obstacle detected by the obstacle detecting unit 121A with information included in the determination criterion information 127. The risk determining unit 124 determines whether or not the degree of risk to the subject vehicle M is equal to or higher than a threshold. The threshold described above, for example, is stored in a storage device as a part of the determination criterion information 127. For example, the risk determining unit 124 determines that the degree of risk to the subject vehicle M is equal to or higher than the threshold in a case in which a tank truck or the like has rolled over across a plurality of lanes (for example, all lanes). In a case in which the degree of risk to the subject vehicle M is equal to or higher than the threshold, the risk determining unit 124 outputs a signal indicating that to the action plan generating unit 123.

In a case in which the degree of risk determined by the risk determining unit 124 is equal to or higher than the threshold, the action plan generating unit 123 generates a retreat action plan for the subject vehicle M to retreat. “Retreat” as used in this application does not mean that the subject vehicle M moves backward but is used to mean moving to a position or in a direction in which the degree of safety of a vehicle occupant of the subject vehicle M is high. For this reason, “retreat” as used in this application may also be called “moving,” and “retreat action plan” may also be called “moving plan.” The “retreat action plan (moving plan)” may include at least one control instruction relating to the subject vehicle M.

As illustrated in FIG. 4, the action plan generating unit 123, for example, includes a retreat destination candidate searching unit 123A, a safety determining unit 123B, a retreat destination selecting unit 123C, a front space determining unit 123D, and a locus generating unit 123E.

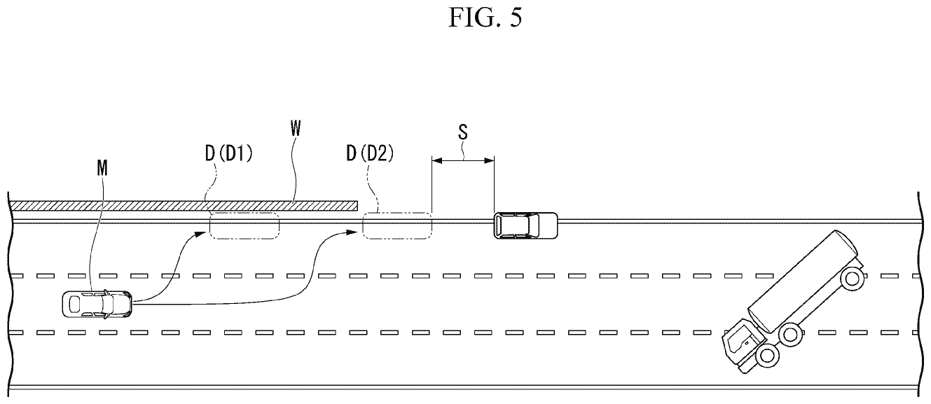

In a case in which an obstacle is detected in front of the subject vehicle M, the retreat destination candidate searching unit 123A searches for a retreat destination candidate D (see FIGS. 5 to 7) to which the subject vehicle M will retreat. In this embodiment, the retreat destination candidate searching unit 123A searches for a plurality of retreat destination candidates D. A retreat destination candidate D, for example, is a space at which the subject vehicle M can stop (stoppable position) on a road between a detected obstacle and the subject vehicle M or within an area of a side of a road (a road shoulder). For example, a retreat destination candidate D is an area near a side of a road (a road shoulder). “Retreat destination candidate” as used in this application may represent only a retreat direction in which the subject vehicle M will move instead of a stoppable position.

The retreat destination candidate searching unit 123A, for example, detects retreat destination candidates D on the basis of at least one of information received from the external system recognizing unit 121, information received from the subject vehicle position recognizing unit 122, information received from the vehicle sensor 40, and the like. The “information received from the external system recognizing unit,” for example, is information relating to positions of a nearby vehicle located in the periphery of the subject vehicle M, a guard rail, an electricity post, a parked vehicle, a person, and other objects. The “information received from the subject vehicle position recognizing unit,” for example, is position information of the subject vehicle M. The “information received from the vehicle sensor,” for example, is speed information, acceleration information, or the like of the subject vehicle M. The retreat destination candidate searching unit 123A, for example, searches for spaces at which the subject vehicle M can be safely stopped by decelerating the subject vehicle M (spaces to which the subject vehicle M can retreat) as retreat destination candidates D on the basis of the information received from the external system recognizing unit 121, the information received from the subject vehicle position recognizing unit 122, the information received from the vehicle sensor 40, and the like. The retreat destination candidate searching unit 123A outputs information relating to a plurality of retreat destination candidates D retrieved by the retreat destination candidate searching unit 123A to the safety determining unit 123B.

The safety determining unit 123B determines (evaluates) degrees of safety of the retreat destination candidates D retrieved by the retreat destination candidate searching unit 123A. For example, the safety determining unit 123B determines a degree of safety of a retreat destination candidate D on the basis of at least a degree of ease for a vehicle occupant to evacuate from the retreat destination candidate D. The safety determining unit 123B, for example, includes a freedom determining unit 123Ba and an evacuation path arrival ease determining unit 123Bb.

The freedom determining unit 123Ba determines a degree of freedom in the periphery of a retreat destination candidate D. The “degree of freedom” represents a degree of freedom of a vehicle occupant to move after exiting the subject vehicle M. For example, the “degree of freedom” is low in a case in which there is an obstacle such as a wall (for example, a fence or a natural slope) next to the retreat destination candidate D. On the other hand, “the degree of freedom” is high in a case in which there is no obstacle such as a wall next to the retreat destination candidate D, and the side of the retreat destination candidate D is open.

The freedom determining unit 123Ba, for example, determines a degree of freedom of the periphery of a retreat destination candidate D on the basis of information (information relating to a lateral environment of a road) received from the external system recognizing unit 121. For example, the freedom determining unit 123Ba determines a degree of freedom by digitalizing an area (volume) of an obstacle present in the periphery of an area set as a retreat destination candidate on the basis of the information relating to the lateral environment of the road. The freedom determining unit 123Ba determines a degree of freedom of each of a plurality of retreat destination candidates D retrieved by the retreat destination candidate searching unit 123A.

The evacuation path arrival ease determining unit 123Bb (hereinafter referred to as an evacuation path determining unit 123Bb), for example, in a case in which the subject vehicle M stops inside a tunnel or the like, determines a degree of ease for a vehicle occupant to move from the subject vehicle M to an evacuation path. For example, the “evacuation path” is an emergency exit (evacuation exit) inside a tunnel or the like.

The degree of ease for a vehicle occupant to move to an evacuation path is low in a case in which the retreat destination candidate D is far from an evacuation path. On the other hand, the degree of ease for a vehicle occupant to move to an evacuation path is high in a case in which the retreat destination candidate D is close to an evacuation path.

The evacuation path determining unit 123Bb, for example, determines a degree of ease for a vehicle occupant to move to an evacuation path on the basis of the position information of a retreat destination candidate D retrieved by the retreat destination candidate searching unit 123A and position information of an evacuation path. In other words, the evacuation path determining unit 123Bb, for example, determines a degree of ease for a vehicle occupant to move to an evacuation path on the basis of a distance between a retreat destination candidate D and the evacuation path. The position information of an evacuation path, for example, may be acquired from the first map information 54 of the navigation device 50 or the second map information 62 of the MPU 60, may be acquired from information input from the external system recognizing unit 121, or may be acquired from information received from a communication facility installed on a road through the communication device 20. The evacuation path determining unit 123Bb determines a degree of ease for a vehicle occupant to move to an evacuation path for each of a plurality of retreat destination candidates D retrieved by the retreat destination candidate searching unit 123A.

The safety determining unit 123B determines a degree of safety of a retreat destination candidate D on the basis of at least one of a result of determination of a degree of freedom of a retreat destination candidate D determined by the freedom determining unit 123B a and a result of determination of a degree of ease for a vehicle occupant to move to an evacuation path determined by the evacuation path determining unit 123Bb. For example, the safety determining unit 123B determines a degree of safety of a retreat destination candidate D to be higher as the degree of freedom of the retreat destination candidate D is higher. The safety determining unit 123B determines a degree of safety of a retreat destination candidate D to be higher as a degree of ease for a vehicle occupant to move to the evacuation path is higher. The safety determining unit 123B determines a degree of safety of each of a plurality of retreat destination candidates D retrieved by the retreat destination candidate searching unit 123A.

FIGS. 5 to 7 are diagrams illustrating an example of a plurality of retreat destination candidates D retrieved by the retreat destination candidate searching unit 123A. For example, FIG. 5 is a case in which there is part in which a wall (a fence, a natural slope face, or the like) W extends partially along a side of a road. In the example illustrated in FIG. 5, a plurality of retreat destination candidates D include at least a first retreat destination candidate D1 and a second retreat destination candidate D2. The second retreat destination candidate D2 is farther away than the first retreat destination candidate D1 when seen from the subject vehicle M. In other words, the second retreat destination candidate D2 is closer to the obstacle than the first retreat destination candidate D1. In the example illustrated in FIG. 5, the first retreat destination candidate D1 is located next to the wall W. On the other hand, the second retreat destination candidate D2 is located away from the side of the wall W. For this reason, a degree of freedom of the second retreat destination candidate D2 determined by the freedom determining unit 123B a is higher than a degree of freedom of the first retreat destination candidate D1. For this reason, in the example illustrated in FIG. 5, the safety determining unit 123B determines that the degree of safety of the second retreat destination candidate D2 is higher than the degree of safety of the first retreat destination candidate D1. The second retreat destination candidate D2 is not limited to a side of a road on a side opposite to an oncoming lane (opposite lane) with respect to the center of a running lane. The second retreat destination candidate D2 may be an area on the side of the oncoming lane with respect to the center of the running lane. In other words, the second retreat destination candidate D2, for example, may be positioned at a side adjacent to the oncoming lane in the running lane or a lane group having the same advancement direction including the running lane.

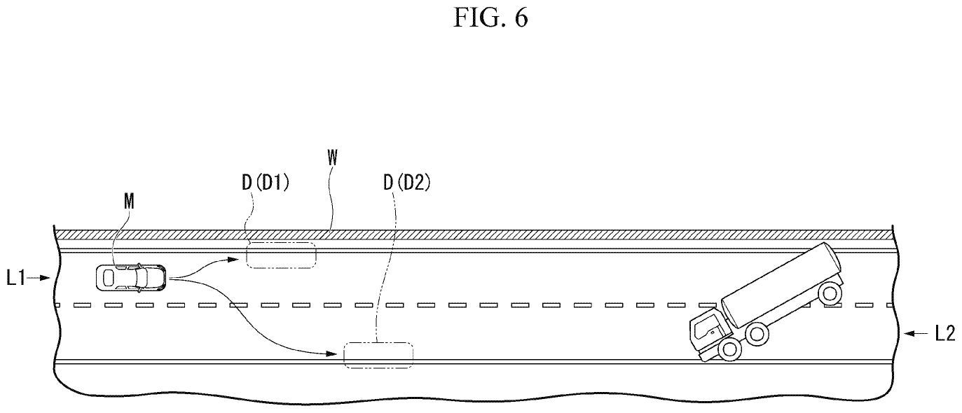

FIG. 6 is a case in which there is a vehicle involved in an accident across all lanes including a running lane L1 of the subject vehicle M and an oncoming lane (opposite lane) L2. In the example illustrated in FIG. 6, a plurality of retreat destination candidates D at least include a first retreat destination candidate D1 and a second retreat destination candidate D2. The second retreat destination candidate D2 is farther away than the first retreat destination candidate D1 when seen from the subject vehicle M. In other words, the second retreat destination candidate D2 is closer to the obstacle than the first retreat destination candidate DE For example, in a case in which there is an obstacle across all the lanes including the running lane L1 of the subject vehicle M and the oncoming lane L2, the retreat destination candidate searching unit 123A may search for retreat destination candidates D also including an area of the oncoming lane L2. In the example illustrated in FIG. 6, the first retreat destination candidate D1 is positioned in the running lane (its own lane) L1 or at a side (a road shoulder) of the running lane L1. The second retreat destination candidate D2 is positioned in the oncoming lane L2 or on a side (road shoulder) of the oncoming lane L2. In the example illustrated in FIG. 6, there is a wall W next to the running lane L1. On the other hand, there is no large obstacle such as a wall W next to the oncoming lane L2. For this reason, a degree of freedom of the second retreat destination candidate D2 determined by the freedom determining unit 123Ba is higher than a degree of freedom of the first retreat destination candidate DE For this reason, in the example illustrated in FIG. 5, the safety determining unit 123B determines that the degree of safety of the second retreat destination candidate D2 is higher than the degree of safety of the first retreat destination candidate D1.

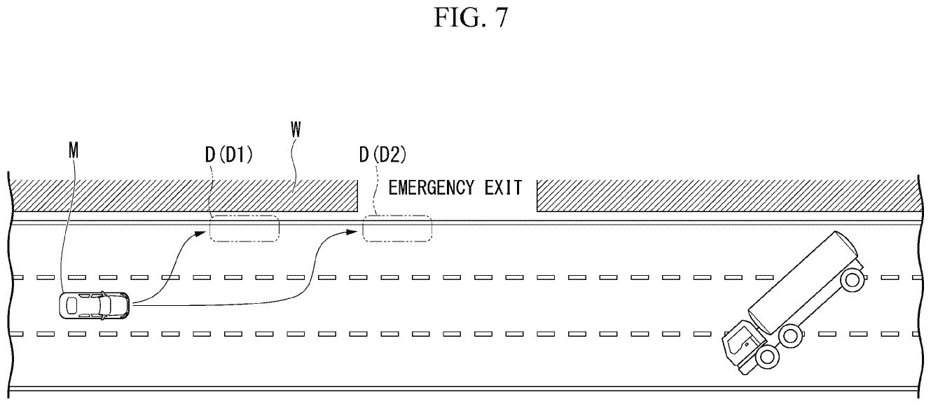

FIG. 7 is a case of an encounter with an obstacle inside a tunnel. In the example illustrated in FIG. 7, a plurality of retreat destination candidates D include at least a first retreat destination candidate D1 and a second retreat destination candidate D2. The second retreat destination candidate D2 is farther away than the first retreat destination candidate D1 when seen from the subject vehicle M. In other words, the second retreat destination candidate D2 is closer to the obstacle than the first retreat destination candidate D1. In the example illustrated in FIG. 7, the second retreat destination candidate D2 is closer to an evacuation path than the first retreat destination candidate D1. For this reason, a degree of ease for a vehicle occupant to move from a second retreat destination candidate D2 determined by the evacuation path determining unit 123Bb to the evacuation path is higher than a degree of ease for a vehicle occupant to move from the first retreat destination candidate D1 to the evacuation path. For this reason, in the example illustrated in FIG. 7, the safety determining unit 123B determines that a degree of safety of the second retreat destination candidate D2 is higher than a degree of safety of the first retreat destination candidate D1.

Referring back to FIG. 4 for description, the retreat destination selecting unit 123C selects one retreat destination candidate D from among a plurality of retreat destination candidates D retrieved by the retreat destination candidate searching unit 123A on the basis of a result of determination of a degree of safety of each retreat destination candidate D determined by the safety determining unit 123B. The retreat destination selecting unit 123C, for example, selects a retreat destination candidate D of which a degree of safety, which is determined by the safety determining unit 123B, is the highest from among a plurality of retreat destination candidates D as a retreat destination at which the subject vehicle M will retreat. For example, in a case in which there are a plurality of retreat destination candidates D satisfying a degree of safety that is a predetermined level or more, the retreat destination selecting unit 123C may select a retreat destination candidate D that is separated the most from the obstacle from among them, as a retreat destination at which the subject vehicle M will retreat. In a case in which degrees of safety of a plurality of retreat destination candidates D are the same, for example, the retreat destination selecting unit 123C may select a retreat destination candidate D that is separated most from the obstacle as a retreat destination at which the subject vehicle M will retreat.

As described above, the action plan generating unit 123 generates a retreat action plan for the subject vehicle M on the basis of a degree of safety of the retreat destination candidate D determined by the safety determining unit 123B. In this embodiment, the action plan generating unit 123 generates a retreat action plan for the subject vehicle M on the basis of degrees of safety of a plurality of retreat destination candidates D determined by the safety determining unit 123B. For example, in a case in which the degree of safety of the second retreat destination candidate D2 is higher than the degree of safety of the first retreat destination candidate D1, the action plan generating unit 123 generates a retreat action plan for the subject vehicle M to retreat to the second retreat destination candidate D2. The “retreat action plan” described in this embodiment, for example, includes at least determination of a retreat destination (a stop position of the subject vehicle M).

In a case in which the subject vehicle M is caused to stop at the retreat destination candidate D selected by the retreat destination selecting unit 123C, the front space determining unit 123D determines the size of the front space S of the subject vehicle M. The “front space S” is a space (for example, an inter-vehicle distance) between the subject vehicle M and an object (for example, a nearby vehicle) positioned in front of the subject vehicle M. In a case in which the subject vehicle M is caused to stop in accordance with a retreat action plan, the front space determining unit 123D sets a space wider than a space set in front of the subject vehicle M at the time of stopping the subject vehicle M in a state in which an obstacle of which a degree of risk in normal automated driving realized by the automated driving control unit 100 is equal to or higher than the threshold described above is not detected as a front space S of the subject vehicle M. The “normal automated driving” is a “normal automated driving mode” to be described later. For example, in a case in which the subject vehicle M is caused to stop in accordance with a retreat action plan, the front space determining unit 123D sets a space wider than a space (an inter-vehicle distance at the time of normal stopping of the subject vehicle M) set between the subject vehicle M and a vehicle running ahead at the time of stopping the subject vehicle M in automated driving realized by the automated driving control unit 100 as a front space S of the subject vehicle M. In addition, from another point of view, in a case in which the subject vehicle M is caused to stop in accordance with a retreat action plan, the front space determining unit 123D sets a space wider than a space set in front of the subject vehicle M in an action plan in the middle of execution using the subject vehicle M immediately before generation of the retreat action plan described above as a front space S of the subject vehicle M.

The locus generating unit 123E generates a locus allowing the subject vehicle M to run from the current position of the subject vehicle M to the retreat destination candidate D selected by the retreat destination selecting unit 123C. The locus generating unit 123E outputs information relating to the generated locus to the running control unit 141.

The automated driving control unit 100 may transmit information relating to an obstacle detected by the obstacle detecting unit 121A, the magnitude of a degree of risk determined by the risk determining unit 124, and the like to a nearby vehicle through inter-vehicle communication performed through the communication device 20. In addition, the automated driving control unit 100 may generate a retreat action plan for other vehicles that are nearby vehicles using the action plan generating unit 123 and transmit the retreat action plan to other vehicles.

Next, as functional units enabling guidance of the subject vehicle M after the subject vehicle M stops, and a driver gets off, the automated driving mode control unit 125 (see FIG. 1) and the guidance accepting unit 126 will be described.

The automated driving mode control unit 125 switches the automated driving mode realized by the automated driving control unit 100 at least between a “normal automated driving mode” and a “limited automated driving mode”. After the subject vehicle M stops in accordance with a retreat action plan generated by the action plan generating unit 123, and a driver gets off, the automated driving mode control unit 125 switches the driving mode of the subject vehicle M to the “limited automated driving mode”.

Here, the “normal automated driving mode”, for example, is an automated driving mode in which automated driving is executed on the basis of an instruction from a qualified vehicle occupant and is an automated driving mode executed at the time of normal running (for example, at the time of running not encountering an accident). The “qualified vehicle occupant”, for example, is a person registered in advance as a user of the subject vehicle M. From another point of view, the “normal automated driving mode” is an automated driving mode in which a predetermined limit applied in the “limited automated driving mode” is not applied.

On the other hand, the “limited automated driving mode”, for example, is an automated driving mode in which automated driving is executed on the basis of an operation performed by a person other than a qualified vehicle occupant (a policeman, an emergency rescue-related person, an accident handling-related person, or the like) and, for example, is an automated driving mode executed after a vehicle occupant including a driver gets off the subject vehicle M and evacuates. The “limited automated driving mode” is an automated driving mode in which at least one of an operation (instruction input) for the subject vehicle M or a moving range of the subject vehicle M is limited.

An operation for the subject vehicle M being limited, for example, is a case in which an operation (instruction input) for the subject vehicle M can be performed only in a case in which a guidance device L registered in advance is used (a remote controller, a guidance lamp, or the like; hereinafter, referred to as a qualified guidance device L) or a case in which it is authenticated that a person performing an operation for the subject vehicle M is a qualified related person corresponding to an accident such as a policeman, an emergency-related person, an accident-handling related person, or the like. A method of authenticating a qualified guidance device L or a qualified related person will be described in description of the guidance accepting unit 126.

The moving range being limited, for example, is a case in which an operation for the subject vehicle M can be performed in a case in which the subject vehicle M stays within a predetermined range (for example, within 10 m) from a position at which the subject vehicle M has stopped (a position at which the driving mode is switched to the limited automated driving mode). In a case in which the moving range is limited as described above, a mode in which an operation for the subject vehicle M is not limited to a qualified guidance device L or a qualified related person may be additionally prepared.

The guidance accepting unit (acceptance unit) 126 includes an identification unit 126A and an instruction accepting unit 126B.

In a case in which the limited automated driving mode is executed, and an operation for the subject vehicle M is limited, the identification unit 126A determines whether or not a device giving an instruction to the subject vehicle M is a qualified guidance device L. For example, the identification unit 126A may determine that a device giving an instruction to the subject vehicle M is a qualified guidance device L by performing authentication using radio communication through the communication device 20, imaging a guidance device L that flashes at a special frequency using the camera 10, or the like. The identification unit 126A may determine that a person giving an instruction to the subject vehicle M is a qualified related person by performing authentication of an identification component (for example, an ID chip) that is held only by a qualified related person corresponding to an accident through the camera 10 and the communication device 20.

In a case in which it is determined by the identification unit 126A that a device giving an instruction to the subject vehicle M is a qualified guidance device L, the instruction accepting unit 126B accepts a guidance instruction from the guidance device L. In a case in which it is determined by the identification unit 126A that a person giving an instruction to the subject vehicle M is a qualified related person, the instruction accepting unit 126B accepts a guidance instruction from the related person. A guidance instruction from a qualified related person, for example, may be an operation of lightly pushing the subject vehicle M in a desired moving direction, an operation of lightly tapping the subject vehicle M from a desired moving direction, or the like. The instruction accepting unit 126B, for example, may recognize the guidance instruction as described above through an acceleration sensor or the like disposed in the vehicle body as a part of the vehicle sensor 40. The instruction accepting unit 126B accepts a guidance instruction from a qualified guidance device L or a qualified related person and outputs the guidance instruction to the action plan generating unit 123.

The action plan generating unit 123 generates an action plan for the subject vehicle M in the limited automated driving mode on the basis of a guidance instruction accepted by the instruction accepting unit 126B. For example, the action plan generating unit 123 generates an action plan for moving the subject vehicle M in accordance with the guidance instruction accepted by the instruction accepting unit 126B.

Next, one example of the processing flow of the vehicle system 1 relating to an encounter with an obstacle will be described.

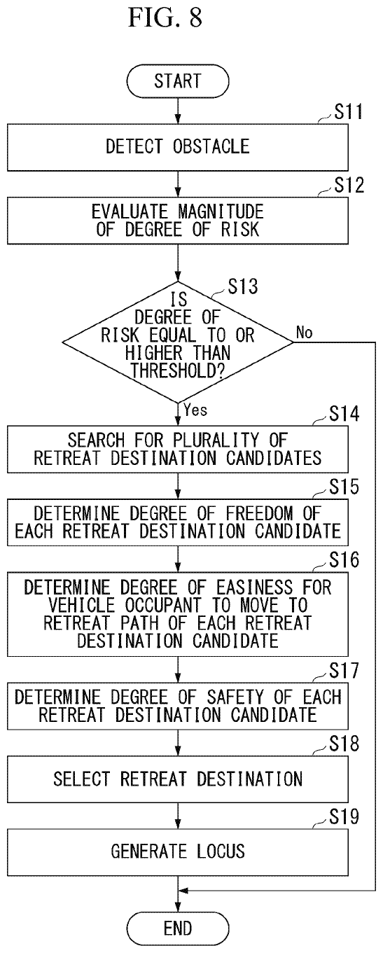

FIG. 8 is a flowchart illustrating one example of a processing flow of the vehicle system 1 relating to an encounter with an obstacle. First, the obstacle detecting unit 121A detects an obstacle in front of the subject vehicle M (Step S11). Next, the risk determining unit 124 determines (evaluates) a magnitude of the degree of risk to the subject vehicle M of the obstacle (Step S12). The risk determining unit 124 determines whether or not the evaluated degree of risk to the subject vehicle M is equal to or higher than a threshold (Step S13).

In a case in which it is determined that the degree of risk to the subject vehicle M is equal to or higher than the threshold, the retreat destination candidate searching unit 123A searches for a plurality of retreat destination candidates D (Step S14). Next, the freedom determining unit 123Ba determines a degree of freedom of each of the plurality of retreat destination candidates D (Step S15). The evacuation path determining unit 123Bb determines a degree of ease for of a vehicle occupant to move to an evacuation path for each of the plurality of retreat destination candidates D (Step S16). Step S16 may be performed before Step S15 or approximately simultaneously with Step S15. Then, the safety determining unit 123B determines a degree of safety of each retreat destination candidate D on the basis of a degree of freedom of the retreat destination candidate D and the degree of ease for a vehicle occupant to move to an evacuation path for each retreat destination candidate D (Step S17).

Next, the retreat destination selecting unit 123C selects a retreat destination candidate D at which the subject vehicle M will retreat among the plurality of retreat destination candidates D on the basis of the degree of safety of each of the plurality of retreat destination candidates D (Step S18). Then, the locus generating unit 123E generates a locus for moving the subject vehicle M from the current position of the subject vehicle M to the retreat destination candidate D (Step S19). The generated locus is output to the running control unit 141. The running control unit 141 moves the subject vehicle M to the retreat destination candidate D by controlling the running driving force output device 200 on the basis of the generated locus. In this way, the retreat of the subject vehicle M is completed.

According to the configuration described as above, additional improvement of the degree of safety of a vehicle occupant can be achieved. For example, generally, in a case in which an obstacle of which a degree of risk is high is detected in front of a vehicle, it is preferable to stop the vehicle as soon as possible in many cases. However, depending on the surrounding environments of a road and the position of an evacuation path, there are also cases in which it is rather preferable that the vehicle should run further instead of immediately stopping. Thus, the vehicle control system according to this embodiment includes the action plan generating unit 123 that searches for a retreat destination candidate D of the subject vehicle M, determines a degree of safety of the retreat destination candidate D, and generates a retreat action plan for the subject vehicle M on the basis of the degree of safety of the retreat destination candidate D. According to such a configuration, in a case in which there is a retreat destination candidate D having a high degree of safety, the subject vehicle M can retreat to the retreat destination candidate D. Accordingly, additional improvement of safety of a vehicle occupant can be achieved. According to the configuration of this embodiment, for example, in a case in which rollover of a vehicle such as a tank truck over all the lanes occurs, the risk of a secondary disaster can be reduced.

In this embodiment, the action plan generating unit 123 determines a degree of safety of a retreat destination candidate D on the basis of a degree of freedom of the retreat destination candidate D for the periphery as ease for a vehicle occupant to evacuate from the retreat destination candidate D. For this reason, for example, also in a case in which the subject vehicle M is caused to stop on the road shoulder of a road, by stopping the subject vehicle on a road shoulder having no wall with priority, the degree of freedom of evacuation of a vehicle occupant who has got off the subject vehicle M can be increased.

In this way, the degree of safety of a vehicle occupant who has got off the subject vehicle M can be further increased.

In this embodiment, the degree of safety of a retreat destination candidate D is determined on the basis of at least one of a degree of ease for a vehicle occupant to move to an evacuation path. For this reason, for example, in a case in which an obstacle is detected inside a tunnel, the subject vehicle M can be caused to stop at a place close to an evacuation path (emergency exit) inside the tunnel. In this way, the degree of safety of a vehicle occupant who has got off the subject vehicle M can be further increased.

While forms for performing the present invention have been described using the embodiments, the present invention is not limited to such embodiments, and various modifications and substitutions may be made within a range not departing from the concept of the present invention.

For example, in a case in which an obstacle is detected in front of the vehicle by the obstacle detecting unit 121A, the retreat destination candidate searching unit 123A may first search for only one retreat destination candidate D. Then, a degree of safety of the retrieved retreat destination candidate D is determined by the safety determining unit 123B, and in a case in which it is determined that there is a sufficient degree of safety from points of view of the degree of freedom, the degree of ease for a vehicle occupant to move to an evacuation path, and the like, a retreat action plan for the subject vehicle M to retreat to the retreat destination candidate D may be generated.

### REFERENCE SIGNS LIST

1 vehicle system

100 automated driving control unit (an automated driving control part or an in-vehicle computer)

121A obstacle detecting unit (detection unit)

123 action plan generating unit

124 risk determining unit

125 automated driving mode control unit

126 guidance accepting unit (acceptance unit)

M subject vehicle (vehicle)

D retreat destination candidate

D1 first retreat destination candidate

D2 second retreat destination candidate

S front space

What is claim is:

1. A vehicle control system comprising:
a detection unit configured to detect an obstacle in front of a vehicle;
a risk determining unit configured to determine a degree of risk to the vehicle of the obstacle detected by the detection unit; and
an action plan generating unit configured to search for a retreat destination candidate for the vehicle, determine a degree of safety of the retreat destination candidate, and generate a retreat action plan for the vehicle on the basis of a result of the determination of the degree of safety of the retreat destination candidate in a case in which the degree of risk determined by the risk determining unit is equal to or higher than a threshold.

2. The vehicle control system according to claim 1, wherein the action plan generating unit searches for a plurality of retreat destination candidates, determines a degree of safety of each of the plurality of retreat destination candidates, and generates the retreat action plan on the basis of a result of the determination of the degree of safety of each of the plurality of retreat destination candidates.

3. The vehicle control system according to claim 2,
wherein the plurality of retreat destination candidates include a first retreat destination candidate and a second retreat destination candidate that is located farther away than the first retreat destination candidate when seen from the vehicle, and
wherein the action plan generating unit generates a retreat action plan for the vehicle to retreat to the second retreat destination candidate in a case in which a degree of safety of the second retreat destination candidate is higher than a degree of safety of the first retreat destination candidate.

4. The vehicle control system according to claim 1, wherein the action plan generating unit determines the degree of safety of the retreat destination candidate on the basis of at least a degree of ease for a vehicle occupant to evacuate from the retreat destination candidate.

5. The vehicle control system according to claim 4, wherein the action plan generating unit determines the degree of safety of the retreat destination candidate on the basis of at least a degree of freedom in the periphery of the retreat destination candidate as the degree of ease for the vehicle occupant to evacuate from the retreat destination candidate.

6. The vehicle control system according to claim 4, wherein the action plan generating unit determines the degree of safety of the retreat destination candidate on the basis of at least a degree of ease for the vehicle occupant to move to an evacuation path as the degree of ease for the vehicle occupant to evacuate from the retreat destination candidate.

7. The vehicle control system according to claim 1, wherein, in a case in which the vehicle is caused to stop in accordance with the retreat action plan, the action plan generating unit sets a space wider than a space set in front of the vehicle at the time of stopping the vehicle as a front space of the vehicle in automated driving realized by an automated driving control unit executing at least one of speed control and steering control of the vehicle.

8. The vehicle control system according to claim 1, further comprising:
an automatic driving mode control unit configured to switch a driving mode of the vehicle to a limited automated driving mode in which at least one of an operation for the vehicle and a moving range of the vehicle is limited; and
an acceptance unit configured to accept a guidance instruction from the outside in the limited automated driving mode,
wherein the action plan generating unit generates an action plan for the vehicle in the limited automated driving mode on the basis of the guidance instruction accepted by the acceptance unit.

9. A vehicle control method using an in-vehicle computer, the vehicle control method comprising:
detecting an obstacle in front of a vehicle;
determining a degree of risk to the vehicle of the obstacle; and
searching for a retreat destination candidate for the vehicle, determining a degree of safety of the retreat destination candidate, and generating a retreat action plan for the vehicle on the basis of a result of the determination of the degree of safety of the retreat destination candidate in a case in which the degree of risk is equal to or higher than a threshold.

10. A vehicle control program causing an in-vehicle computer to execute:
detecting an obstacle in front of a vehicle;
determining a degree of risk to the vehicle of the obstacle; and
searching for a retreat destination candidate for the vehicle, determining a degree of safety of the retreat destination candidate, and generating a retreat action plan for the vehicle on the basis of a result of the determination of the degree of safety of the retreat destination candidate in a case in which the degree of risk is equal to or higher than a threshold.
